(19) United States
(12) Patent Application Publication
(10) Pub. No.: US 2003/0101070 A1
(43) Pub. Date: May 29, 2003

(54) Method for preparing and electronically filing environmental permits and reports via the internaet

(76) Inventors: Keith J. Mahosky, Jeannett, PA (US); Gerald E. Williams, Pittsburgh, PA (US)

Correspondence Address: Cohen & Grigsby, P.C., 15th Floor, 11 Stanwix Street, Pittsburgh, PA, 15222, US

(21) Appl. No.: 10/222,740

(22) Filed: Aug. 16, 2002

Related U.S. Application Data
(60) Provisional application No. 60/313,378, filed on Aug. 17, 2001.

(51) Int. Cl. G06F 17/60

(52) U.S. Cl. 705/1

(57) ABSTRACT

Methods are disclosed for developing an approach that supports the preparation of electronically completed and filed environmental permits and reports. This method combines a novel and unique application of commercial software, customized form wizards and tailored software to support the web based completion of environmental permits. Computer methods described as support wizards have been developed for a novel and unique application and are an integral part of this new application.

### CROSS-REFERENCE

This application claims the priority benefit of provisional U.S. Patent Application Serial No. 60/313,378 filed Aug. 17, 2001.

### BACKGROUND OF THE INVENTION

There are approximately 3.1 million environmental permit holders, industry employees, government workers, environmental attorneys and environmental education-related people in the U.S. Environmental Technologies and Services Industry. This group consists of companies and employees of the U.S. Environmental Technologies and Services Industry which, broadly defined, includes:

Companies who must file regulatory permits

Suppliers

Waste management companies

Consultants

Federal, state, provincial and local public agencies who process permits and reports

Professors, students and research scientists

Environmental lawyers

The commercial permitting market is serviced by environmental consultants, environmental attorneys or by corporate environmental staff. It is a time-intensive process. While directions are often provided by the agency to which the form is submitted, it often takes an engineer or experienced individual a significant amount of additional time to accurately complete a form that results in agency approval. These individuals are paid on an hourly basis to resolve and support form completion. The environmental permitting and report arena encompasses over 2 million different documents that are submitted annually in the United States alone.

Environmental permits and reports are filed by companies and individuals who emit, produce or store materials that are potentially harmful to people and the environment. These documents are filed at the federal, state, province and local government levels. They are submitted using forms prepared by the governmental agency that can range from the very simple to the extremely complex. The permit forms are available either in a paper format or electronically downloadable forms that can be printed for submission. Some other forms can be submitted on a standard sized floppy disk.

With an estimated average cost to complete of $5000 USD for each permit or report, and a paper-based process, industry spends billions on meeting environmental regulatory requirements. By defining a method whereby permit holders and report filers can now complete and submit the forms required by regulatory agencies with web-based electronic assistance and built in form guidance, these companies can now receive significant time and cost savings over existing methodologies.

In general, the software tools and website of the present invention provide the same level of service on a much quicker timetable using new computer-based tools prepared specifically for environmental permitting and compliance applications. The software tools and the associated website provide form completion support for clients, improved awareness of filers regarding general and user specific regulatory requirements, and facilitates electronic filing and approval notification with regulatory agencies. In addition, this site assists those permit holders who possess environmental emission reduction credits or the equivalent in buying and selling those credits.

The user interface and functionality of the software is modeled in a fashion similar to Intuit's TurboTax® program, which simplifies and automates the filing of personal and small business income tax. Unlike TurboTax®, the software does not need to be written for several different operating systems such as Windows or Mac systems, nor does it need to be produced and distributed via disc or CD-ROM. The application of the interface and functionality to the environmental permitting and reporting industry in a method that can run on any operating system that supports a web browser is a novel and unique approach.

Personal computer based software has been developed and is commercially available that provides the form necessary for preparing environmental permits. These products require purchase of updated software to address changes in the environmental permitting regulations. Unlike this software, the method uses internet based on-line access to the necessary permit forms and supports them on-line with embedded wizards that provide detailed instructions using draw down text boxes for specific permit line items, and also provides embedded links to necessary support and information websites for Federal, State, and local regulatory agencies; suppliers and vendors of environmental compliance equipment, hardware and services; and an on-line support interface if questions are encountered during the permit application process. Additionally, the method facilitates eventual direct electronic filing of permits and reports.

The features of the present invention are fully integrated for optimal client use. These features allow the user to incorporate all of the advantages of the Internet in preparing, managing and tracking his or her environmental needs. The user interface and functionality of the software is modeled in a fashion that simplifies and automates not only the completion of documents, but also the filing of environmental permits and reports. The software does not need to be written for several different operating systems nor does it need to be produced and distributed via CD-ROM or other costly distribution channels. The application can run on operating systems that support a web browser. This is important since it allows corporate, legal and consultant end-users to access, work on, or print their application anywhere where they can establish an Internet connection. Software used in the development of this methodology includes off the shelf technology products for web site construction, data base development, website programming, and middleware development. Additionally, some of the components may be developed using proprietary methods or programs.

### SUMMARY OF THE INVENTION

This invention describes an electronic web-based method to prepare, to support the preparation, and to support the electronic filing of electronically completed environmental permits and reports. This approach uses:

Permit and report form wizards,

Decision tree software for permit and form selection

E-Auditor of existing permits

Integrated regulatory compliance calendar for notification

Emission Reduction Credit electronic market place

Electronic form filing

Electronic notification of approval by the regulatory agency

Two of the essential components of this approach are the use of decision tree software for form selection and a form specific wizard that guides and assists the filer in preparing a form more quickly and accurately with a substantial reduction over traditional costs.

The decision tree software assists site users who are unsure as to which form or report is right for them by assisting in the selection of the appropriate environmental permit or report for their specific needs. By answering a series of questions, the software recommends the particular form or environmental report that a user needs to meet his or her specific environmental compliance requirements. The decision tree software assists clients to:

Determine the specific environmental permit or report form required for their facility

Allow users to input all key fields and data necessary for their respective permits

Guide users through the required procedures for obtaining site-specific input data and information

Perform all necessary computations and calculations on the form

Print out a hard copy of the completed permit application

Store data so that it can be used in subsequent forms or for electronic submission to the regulatory agency

Provide inputs developed by regulators in correspondence, conversation and electronically that aids users in preparing better forms to speed regulatory approval

Once a user has identified the correct form or report, either by prior knowledge or by use of the decision tree software described above, the user is directed to a wizard that assists him or her in the completion of the document. The form or report is either downloaded directly from a regulatory site or pulled from the wizard database. The wizard is proprietary in nature and is either an overlay for the form/report or is a separate form entirely. Some of the wizard's basic features include:

The ability to walk the user through a series of questions required for document completion

Prompt the user to complete various data items pertinent to the selected form/report

Connect the user to support sites provided by other agencies and organizations

Connect the user to appropriate regulations, codes, guidance documents and instructions; assist the user in calculations

Connect the user to other vendors or organizations who can supply supplemental information and services that support form/report completion

Links to both job posting and Request for Proposal/Request for Qualification (RFP/RFQ) modules for environmental professionals

A State/Province by State/Province link directory that allows users to access similar permit locations with 1 or 2 clicks for all similar jurisdictions in a given nation.

A separate useful feature that is a component of this invention consists of the ability to directly notify users through a specifically tailored regulatory compliance calendar. The regulatory calendar can be either automated or manually supported, printed or electronic in format and maintained either online or offline so that it informs the user of pending environmental permits and reports that are (a) required of the user, (b) impact the users specific environmental compliance status, and (c) are available to the user by accessing the form wizards and decision tree software described above. It focuses the user on important form and report filing dates, changes in format and regulations, additional filing requirements not previously in force and changes in regulatory interpretation of forms that are submitted. This feature is not essential in the use of the form wizards described above.

To assist potential users who have filed forms manually or through means other than this invention, an electronic auditor tool “E-Auditor” is provided to assist in the evaluation of previously submitted or approved permits. This aids users in converting the previously submitted form into a format that is compatible with future preparation and filing of permits using this system. While it is not essential to use this feature of the invention to enjoy the full benefits of the system, it attracts form filers who have not previously used the invention to file modifications or new forms/reports using this invention.

Another useful feature of this invention is the development of an interactive Emissions Reduction Credit (ERCs) module that serves as an integrated national marketplace for buyers and sellers of ERCs. ERCs can result from modifications to environmental permits, have a finite shelf life before they expire and can be very valuable to a potential buyer in limiting the cost of pollution control equipment installation at either a new facility or a facility/process that is undergoing modification. Some site users who require form completion support find this feature helpful. Other potential users simply have a centralized marketplace to visit to bid for and buy ERCs.

Another primary feature of this invention is the ability of the form wizards to interface with a network of partnered companies to assist in the completion and electronic filing of environmental permits and reports. These partners are vendors, suppliers and other service providers who support certain aspects of permit completion to ensure that users can submit a complete document to the regulatory agencies.

An important feature of the invention is the ability of the user to automatically electronically file for regulatory approval of a permit developed using any combination of the components described above. This component of the system has the capability to work with regulatory agencies at the Federal, State/Provincial and local municipality levels.

Yet another important feature that this commercial electronic website possesses is the ability to facilitate electronic approval notification by the pertinent regulatory agency. This allows users to have a one-stop shop for preparing, filing and receiving approval for all environmental permits and reports.

Another set of useful features on the site is an interactive module for both environmental professionals job postings and a corporate RFP/RFQ module. Users of the site can search for environmental compliance professionals to add to their staffs and professionals can place their resumes online for review. The RFP/RFQ module allows the corporate user of this invention to place project bid opportunities on the site or to request users and partners to provide qualifications regarding environmental projects. This allows a fully integrated site for the environmental compliance community and aids users by offering immediate support requests that can result from the completion of an environmental permit or report.

Another important information feature of the invention is the development of a State/Province-by-State/Province link directory that allows users to access similar permit locations with 1 or 2 clicks for all similar jurisdictions in a given nation. This feature allows site users to research information in a simpler and organized fashion for a wide variety of jurisdictions without the need to independently go to that jurisdiction's website and “hunt down” similar information.

In total, while this invention has been developed as an electronic Internet Website or similar electronic venue capable of providing the specific combination of the component and features described above, it is not limited to these features, and other advantages of the invention will become apparent from a perusal of the following detailed description of the presently preferred embodiments of the invention taken in connection with the accompanying drawings.

### DETAILED DESCRIPTION OF THE PRESENTLY PREFERRED EMBODIMENTS

General Website

An Internet Website or similar electronic venue is constructed to provide any combination of the components comprising the invention. A flowchart is provided in Attachment A that details the specific site sections related to the key components of the invention. The key components of this site are:

Decision tree software for permit and form selection

Permit and report form wizards,

E-Auditor of existing permits

Integrated regulatory compliance calendar for notification

Emission Reduction Credit electronic market place

Electronic form filing

Electronic notification of approval by the regulatory agency

In general, the website can be developed using any variety of commercially available off-the-shelf web design software or proprietary software/software modules. All features are accessible through this single site, although some components or modules may be hosted separately. The decision tree software uses any combination of off-the-shelf programming software and individually designed software for user interface, middleware or database design.

The decision tree software and form wizards support Federal Government environmental forms and permits, State or Province level environmental forms and permits as well as local environmental permits or forms required to be submitted by the users. These reports and forms could be submitted not only in the United States, but also in other nations with similar environmental regulations and requirements.

Each environmental permit application form or environmental reporting form shall be programmed into its own discrete “wizard”, which automates the task of completing the form. The wizard shall be delivered via the World Wide Web (WWW) using HTML, DHTML, Java, Java Server Pages (JSP), Active Server Pages (ASP) and other similar methods. Each wizard shall provide hyperlinks to applicable regulatory policy and guidance, informational locations on the WWW that enhance user understanding or ease of use of the site, and will be augmented by professional guidance and help by earthpermit.com environmental engineers. As necessary, wizards may include applets to assist in the correct calculations of reporting figures.

Each wizard, although unique and tailored to handle a single, specific form, shall be based on a standard development template(s) using JSP, ASP or similar methods. The templates serve to facilitate a common development process, the software maintenance process, and establish a common look-and-feel for users. A common database using any combination of off the shelf database products such as Oracle, MS SQL, Postgresql, etc. and proprietary database approaches are developed for various components of the invention to support improved integration and performance.

HTML, the language of the WWW, is used for form processing. Java applets for computations and logic agents are run through a Java enabled web browser. A database server maintains customer identification records, invoice and transaction records, and form data provided by the wizards. Environmental forms can be uploaded from regulatory sites and downloaded for user needs as PDF files.

The site provides a single integrated location for users interested in obtaining environmental compliance information. The additional features that would attract users to this invention include:

Links to a job posting module

A State/Province by State/Province link directory that allows users to access similar permit locations with 1 or 2 clicks for all similar jurisdictions in a given nation.

Decision Tree Software

Any combination of the features cited above or the features of the invention described herein attract clients to use the site. Once a prospective user has entered the site , he or she may choose to use the decision tree software. This portion of the invention is anticipated to be used by individuals that either know nothing about their specific environmental permit requirements or by those who are somewhat knowledgeable but, unsure as to which exact form or permit is required.

The decision tree assists site users who are unsure as to which form or report is right for them by assisting in the selection of the appropriate environmental permit or report for their specific needs. By answering a series of questions, the software recommends the particular form or environmental report that a user needs to meet his or her specific environmental compliance requirements. The decision tree is designed to incorporate regulatory guidance, form instructions and the appropriate regulations in its question and answer format. Upon completion of form selection, the user is then automatically connected to the form wizard described below for document preparation.

Attachment B provides an example of the decision tree guide that can be used for the Federal Form R. This form is required to be submitted by all companies within a specified industrial code classification for accidental releases of regulated chemicals. Currently, the annual submittal of Form Rs (also known as Toxic Chemical Release Inventory [TRI] reporting) is a federal program under SARA (Superfund Amendment and Reauthorization Act), Title III.

The annual reports for facilities subject to this program are due July 1. A reporting year is represented by the months of January through December of the previous calendar year i.e. Form Rs due on Jul. 1, 2000 are actually based on calendar year 1999 information. The user has the option to proceed through the determination analysis that would take the step by step evaluation by determining the answers to the questions asked in the decision tree example detailed in Attachment B.

Form and Report Wizards

Once a user has identified the correct form or report for his or her use, either by prior knowledge or by use of the decision tree software described above, the user is directed to a wizard that assists him or her in the completion of the document. The form or report either is downloaded directly from a regulatory site or pulled from the wizard database.

Some of the wizard's basic features include:

The ability to walk the user through a series of questions required for document completion

Prompt the user to complete various data items pertinent to the selected form/report

Connect the user to support sites provided by other agencies and organizations

Connect the user to appropriate regulations, codes, guidance documents and instructions; assist the user in calculations

Connect the user to other vendors or organizations who can supply information, products or services that support form/report completion

The wizards of this invention have imbedded questions that lead to pop-up boxes, additional linked forms, or pull-down menus. Support links both within the site and to outside sites provide instant access and return capability to support the user's potential need to review Federal, State, or local regulations; agency guidance documents; supporting technical data such as Material Safety Data Sheets, vendor specifics on the operational performance of pollution control and discharge equipment; information on Standard Industrial Code classifications, Latitude and Longitude, etc.; and any other supporting data links needed for the completion and filing of an environmental permit or report. Additionally, this feature is integrated into the form wizard in such a way that it remembers the answers to the questions, inserts them into the database associated with this client and incorporates the answers into each form as appropriate to make it easier for a user to complete the form.

The form wizard interfaces with a network of both partnered companies and internet sites that can provide support as well, to assist in the completion and electronic filing of environmental permits and reports. These partners are vendors, suppliers, various industry journals and publications as well as other service providers who support certain aspects of permit completion to ensure that users can submit a complete document to the regulatory agencies. The module that contains the information on these organizations can be directly linked to the form wizards, though it is not essential in the function of each wizard. The module delivers links using HTML, DHTML, Java, Java Server Pages (JSP), Active Server Pages (ASP), PDF files and other similar methods.

An example of this component can be described in the preparation of a major source air permit. In many regulatory jurisdictions, it is necessary for a permit applicant to complete a source stack test of the air emissions from the permitted process. A user with a plant in another jurisdiction than the one in which he currently resides can access this component of the invention to identify a vendor local to the facility to provide this support. This can result in substantial savings of time and money for that user by eliminating the search and bid process.

The wizards also feature pull down menus, calculation spreadsheets, yes or no questions, links to other sites or links to other questions. These items are all oriented to aid the user in improving his or her understanding of the requirements of the form, the focus of the form and the intent needed for accurate completion. Once completed the form is then available for submission to the appropriate regulatory agency either by mail or electronically as described below. Attachment C provides a series of examples of the form wizard developed for the Federal Form R previously described above in the decision tree portion of the invention.

Compliance Calendar

A separate useful feature that is a component of this invention consists of the ability to directly notify users through a specifically tailored regulatory compliance calendar. The calendar will automatically notify a user of due dates, pertinent changes in a specific form, regulatory changes, etc. Initially, it is a feature that is accessible to site clients who either complete forms with this invention or who are a subscriber to other services. For those who subscribe to this feature without first completing a form or report wizard, a separate question and answer module will assist the user in designing a tailored calendar for their specific needs. The feature alone is not, however, essential in the use of the form wizards described above.

The regulatory calendar can be either automated or manually supported, printed or electronic in format and maintained either online or offline. It informs the user of pending environmental permits and reports that are (a) required of the user, (b) impact the users specific environmental compliance status, and (c) are available to the user. By accessing the form wizards and completing a form through the use of this invention, clients will directly benefit from updated information that will improve their ability to comply with environmental regulations. It focuses the user on important form and report filing dates, changes in format and regulations, additional filing requirements not previously in force and changes in regulatory interpretation of forms that are submitted.

The calendar provides information that is tied directly into the many facets of the form wizards. The calendar can link to changes in form requirements, links to regulatory web site information and improvements in a particular wizard. It is a feature that is continually updated with information that is provided to the user throughout the calendar year. A user can then upon receipt of the information, notify his internal management of the potential impacts, review the new regulations or begin the process of making the necessary modifications that may now be required.

Electronic Auditor

To assist potential users who have filed forms manually or through means other than this invention, an electronic auditor tool “E-Auditor” is provided to assist in the evaluation of previously submitted or approved permits. This aids users in converting the previously submitted form into a format that is compatible with future preparation and filing of permits using this invention. While it is not mandatory to use this feature of the invention to enjoy the full benefits of the wizards and other components of the invention, it attracts form filers who have not previously used the invention to file modifications or new forms/reports using this invention.

This portion of the invention can either be automated or manually accessed, printed or electronic in format (such as a PDF file), transmitted by fax, email or post and is maintained either online or offline. If used, it then allows a client to continue with the appropriate form wizard as described above. It uses off-the-shelf computer programming techniques, tools and languages. Some components are customized and tailored to this specific software application. It can eventually have the ability to obtain a copy of the previously completed form from the regulatory agency and prepare it for future wizard application.

Emission Reduction Credits Marketplace

Another useful feature of this invention is the development of an interactive Emissions Reduction Credit (ERCs) module that serves as an integrated national marketplace for buyers and sellers of ERCs. ERCs can result from modifications to environmental permits, have a finite shelf life before they expire and can be very valuable to a potential buyer in limiting the cost of pollution control equipment installation at either a new facility or a facility/process that is undergoing modification. Some site users who require form completion supports find this feature helpful. Other potential users simply have a centralized marketplace to visit to bid for and buy ERCs.

When completing a permit using the invention described herein, the user will be notified of the potential for ERCs and given the opportunity to automatically link to the ERCs module. The user may also choose to enter the marketplace described later to register his or her ERCs for sale. Additionally, users who complete permits with the wizard component of this invention may be automatically notified by the wizard if ERCs are available on the marketplace module that can be purchased for use in development of this specific permit.

Electronic Filing Module

An important feature of the invention is the ability of a user to automatically file a permit or report completed using the components of this invention. This component of the system has the capability to transmit information to regulatory agencies at the Federal, State/Provincial and local municipality levels in electronic format either by fax, email, post or similar system. The module is developed using a combination of off the shelf software products, and specifically developed modules. The module delivers forms completed using this invention via the World Wide Web (WWW) using HTML, DHTML, Java, Java Server Pages (JSP), Active Server Pages (ASP), PDF files and other similar methods. This part of the invention will notify the user automatically when receipt of the permit or form is acknowledged by the regulatory agency.

Electronic Notification Module

Yet another important feature that this commercial electronic website possesses is the ability to facilitate electronic approval notification by the pertinent regulatory agency. This allows users to have a one-stop shop for preparing, filing and receiving approval for all environmental permits and reports. This component of the system has the capability to transmit information from regulatory agencies at the Federal, State/Provincial and local municipality levels in electronic format either by fax, email or similar system to the website. The module delivers forms completed using this invention via the World Wide Web (WWW) using HTML, DHTML, Java, Java Server Pages (JSP), Active Server Pages (ASP), PDF files and other similar methods.

Module for Environmental Professional Job Postings and Corporate RFP/RFQs

Another set of useful features on the site is an interactive module for both environmental professionals job postings and a corporate RFP/RFQ module. Users of the site can search for environmental compliance professionals to add to their staffs and professionals can place their resumes online for review. The same users who would access the other components of this invention could find compliance personnel to assist them with environmental project support.

The RFP/RFQ module allows the corporate user of this invention to place project bid opportunities on the site or to request users and partners to provide qualifications regarding environmental projects. This allows a fully integrated site for the environmental compliance community and aids users by offering immediate support requests that can result from the completion of an environmental permit or report.

State/Province Link Directory

An important information feature of the invention is the development of a State/Province-by-State/Province link directory that allows users to access similar permit locations with 1 or 2 clicks for all similar jurisdictions in a given nation. This feature allows site users to research information in a simpler and organized fashion for a wide variety of jurisdictions without the need to independently go to that jurisdiction's website and “hunt down” similar information. The link directory will be established in a “tree” fashion for logical searching. By selecting a particular type of link for any jurisdiction, a user will be directly transmitted to the appropriate link, regardless of how the State/Province/Municipality has actually organized its information.

While the invention has been described in connection with what are presently considered to be the preferred embodiments, it is to be understood the invention is not to be limited to the disclosed embodiments, but on the contrary is intended to cover various modifications and equivalent arrangements included within the spirit and scope of the appended claims.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A web-based system to support the preparation and filing of electronically completed environmental permits and reports, comprising the following software components:
a a decision tree for assisting the user in permit and form selection; and
b. at least one wizard for assisting the user in completion of a permit or report.

2. The system of claim 1, further comprising an electronic auditor for conversion of existing permits or reports for use with the system.

3. The system of claim 1, further comprising an integrated calendar for notification of regulatory compliance deadlines and changes.

4. The system of claim 2, further comprising an integrated calendar for notification of regulatory compliance deadlines and changes.

5. The system of claim 1, further comprising an electronic marketplace for the purchase and sale of Emission Reduction Credits.

6. The system of claim 4, further comprising an electronic marketplace for the purchase and sale of Emission Reduction Credits.

7. The system of claim 1, further comprising a means for filing forms electronically with a regulatory agency.

8. The system of claim 6, further comprising a means for filing forms electronically with a regulatory agency.

9. The system of claim 1, further comprising a means for electronic notification of permit or report approval by a regulatory agency.

10. The system of claim 8, further comprising a means for electronic notification of permit or report approval by a regulatory agency.

11. The system of claim 1, wherein said decision tree assists users in the selection of an environmental permit or report by answering a series of questions that lead to a recommendation for use of a particular permit or report, wherein said decision tree provides the following functions:
a. determining the specific environmental permit or report form required for a facility;
b. downloading said permit or report form directly from a regulatory site or from a database;
c. allowing user input of fields and data necessary for completion of the selected permit or report;
d. guiding a user through required procedures for obtaining site-specific input data and information;
e. performing necessary computations and calculations for completion of the selected permit or report;
f. printing a copy of the completed permit application or report;
g. storing input data for use in a subsequent permit or report or for electronic submission to a regulatory agency;
h. entering inputs developed by regulators in correspondence, conversation and electronically.

12. The system of claim 1, wherein said wizard assists users in the completion of an environmental permit or report by answering a series of questions that lead to completion of a particular permit or report, wherein said wizard provides the following functions:
a. leading the user through a series of questions required for permit or report completion;
b. prompting the user to complete data items pertinent to the selected permit or report;
c. connecting the user to sites provided by agencies or organizations that support permit or report completion;
d. connecting the user to regulations, codes, guidance documents or instructions that support permit or report completion;
e. assisting the user in calculations that support permit or report completion;
f. connecting the user to vendors or organizations that supply information, products or services that support permit or report completion;
g. providing links to environmental job postings or Request for Proposal or Request for Qualification packages;
h. providing a link directory for accessing similar permit locations in similar jurisdictions.

13. The system of claim 11, wherein said wizard assists users in the completion of an environmental permit or report by answering a series of questions that lead to completion of a particular permit or report, wherein said wizard provides the following functions:
a. leading the user through a series of questions required for permit or report completion;
b. prompting the user to complete data items pertinent to the selected permit or report;
c. connecting the user to sites provided by agencies or organizations that support permit or report completion;
d. connecting the user to regulations, codes, guidance documents or instructions that support permit or report completion;
e. assisting the user in calculations that support permit or report completion;
f. connecting the user to vendors or organizations that supply information, products or services that support permit or report completion;
g. providing links to environmental job postings or Request for Proposal or Request for Qualification packages;
h. providing a link directory for accessing similar permit locations in similar jurisdictions.

14. A method of using decision tree software to assist users in the selection of an environmental permit or report by answering a series of questions that lead to a recommendation for use of a particular permit or report, wherein said method comprises the following steps:
a. determining the specific environmental permit or report form required for a facility;
b. downloading said permit or report form directly from a regulatory site or from a database;
c. allowing user input of fields and data necessary for completion of the selected permit or report;
d. guiding a user through required procedures for obtaining site-specific input data and information;
e. performing necessary computations and calculations for completion of the selected permit or report;
f. printing a copy of the completed permit application or report;
g. storing input data for use in a subsequent permit or report or for electronic submission to a regulatory agency;
h. entering inputs developed by regulators in correspondence, conversation and electronically.

15. A method of using wizard software to assist users in the completion of an environmental permit or report by answering a series of questions that lead to completion of a particular permit or report, wherein said method comprises the following steps:
a. leading the user through a series of questions required for permit or report completion;
b. prompting the user to complete data items pertinent to the selected permit or report;
c. connecting the user to sites provided by agencies or organizations that support permit or report completion;
d. connecting the user to regulations, codes, guidance documents or instructions that support permit or report completion;
e. assisting the user in calculations that support permit or report completion;
f. connecting the user to vendors or organizations that supply information, products or services that support permit or report completion;
g. providing links to environmental job postings or Request for Proposal or Request for Qualification packages;
h. providing a link directory for accessing similar permit locations in similar jurisdictions.
